(19) United States
(12) Patent Application Publication
(10) Pub. No.: US 2015/0080282 A1
(43) Pub. Date: Mar. 19, 2015

(54) CLEANSING AND FILM-FORMING WASHES FOR TURBINE COMPRESSORS

(71) Applicant: General Electric Company, Schenectady, NY (US)

(72) Inventors: Kalaga Murali Krishna, Bangalore (IN); Rebika Mayanglambam Devi, Bangalore (IN); Padmaja Parakala, Bangalore (IN); Surinder Singh Pabla, Greer, SC (US)

(73) Assignee: General Electric Company, Schenectady, NY (US)

(21) Appl. No.: 14/028,756

(22) Filed: Sep. 17, 2013

(51) Int. Cl. C11D 3/00

(52) U.S. Cl. CPC C11D 3/0073
USPC 510/185

(57) ABSTRACT

Cleansing washes for compressor sections of turbines include one or more surfactants, one or more corrosion inhibiting dispersants, and one or more balance materials selected from a group consisting of water and solvents. The one or more surfactants and the one or more corrosion inhibiting dispersants combine to comprise from about 1 weight percent to about 20 weight percent, as actives, of the cleansing wash.

### BACKGROUND OF THE INVENTION

The subject matter disclosed herein relates to wash compositions and, more specifically, to washes for compressors of turbines.

In a gas turbine engine, the compressor section generally includes multiple stages that have a row of compressor blades (also referred to as “rotor blades” or “rotor airfoils”) and stator blades (also referred to as “stator airfoils”). The compressor blades rotate about a rotor and, thusly, impart kinetic energy to the airflow through the compressor. Directly following the row of compressor blades is a row of stator blades, which remain stationary. Acting in concert, the compressor blades and stator blades turn the airflow and slow the air velocity, respectively, which can increase the static pressure of the airflow through the compressor section. Multiple stages of compressors blades and stator blades can be stacked in an axial flow compressor to achieve the required discharge to inlet air pressure ratio. Compressor and stator blades can thus be secured to rotor wheels and the stator case, respectively, by means of a dovetail or root or base attachment.

In operation, compressor blades may be subject to mechanical stresses and harsh operating conditions because of the rotational velocity of the compressor. These levels of stress combined with other operating conditions may affect the experienced levels of erosion or corrosion or the amount of fouling deposits received thereon. For example, the ambient air pulled in through the compressor section can include constituents that may be corrosive and abrasive to the compressor blades and other such parts. Some components may further be subject to mixtures of hydrocarbon-based lubricating oils, carbonaceous soot, dirt, rust and the like.

Accordingly, alternative methods for cleaning and limiting fouling deposits on compressor blades would be welcome in the art.

### BRIEF DESCRIPTION OF THE INVENTION

In one embodiment, a cleansing wash for a compressor section of a turbine is disclosed. The cleansing wash includes one or more surfactants, one or more corrosion inhibiting dispersants, and one or more balance materials selected from a group consisting of water and solvents. The one or more surfactants and the one or more corrosion inhibiting dispersants combine to comprise from about 1 weight percent to about 20 weight percent, as actives, of the cleansing wash.

In another embodiment, a method is disclosed of washing a compressor section of a turbine. The method includes applying a cleansing wash to a surface of one or more blades of the compressor. The cleansing wash includes one or more surfactants, one or more corrosion inhibiting dispersants, and one or more balance materials selected from a group consisting of water and solvents. The one or more surfactants and the one or more corrosion inhibiting dispersants combine to comprise from about 1 weight percent to about 20 weight percent, as actives, of the cleansing wash.

In yet another embodiment, a film-forming wash for a compressor section of a turbine is disclosed. The film-forming wash includes one or more bases selected from a group consisting of water and solvents, one or more fluoro silanes, and, one or more additional silanes selected from the group consisting of mercapto silane, amino silane, tetraethyl orthosilicate, and succinic anhydride silane. The ratio of the one or more fluoro silanes to the one or more additional silanes is from about 90:10 to about 50:50, and the one or more fluoro silanes and the one or more additional silanes combine to comprise from about 0.5 weight percent to about 10 weight percent of the film-forming wash.

These and additional features provided by the embodiments discussed herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the inventions defined by the claims. The following detailed description of the illustrative embodiments can be understood when read in conjunction with the following drawings, where like structure is indicated with like reference numerals and in which:

FIG. 1 is a schematic illustrating a potential operating environment for one or more embodiments shown or described herein;

FIG. 2 is a schematic illustrating exemplary embodiments of a wash system according to one or more embodiments shown or described herein; and,

FIG. 3 is a method for washing a compressor section of a turbine according to one or more embodiments shown or described herein.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

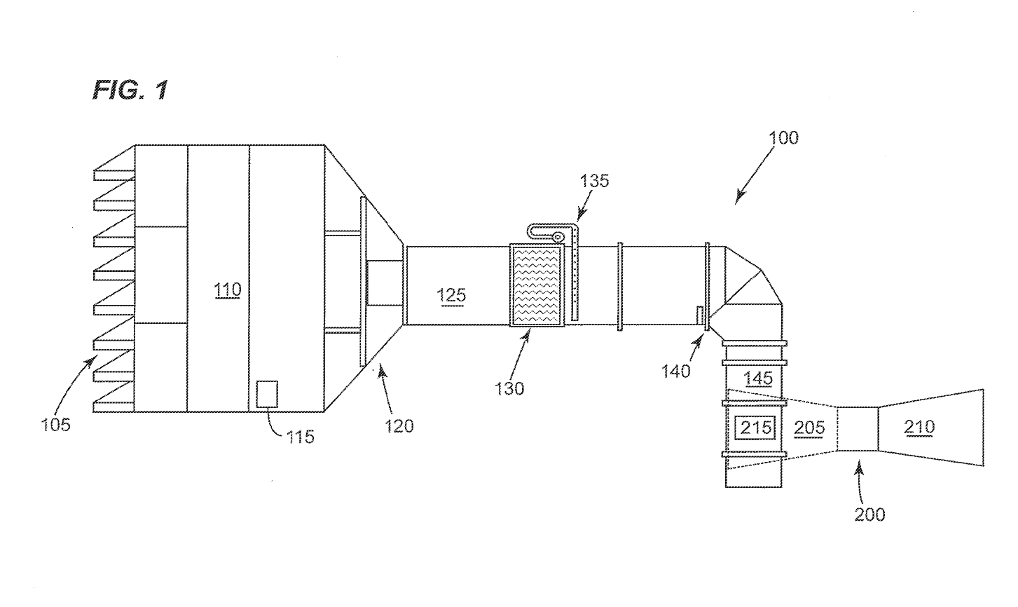

Referring now to the figures, where the various numbers represent like elements throughout the several views, FIG. 1 is a schematic illustrating an environment where an embodiment of the presently disclosed washes may be utilized. FIG. 1 illustrates an inlet system 100 that may be integrated with a compressor 205 of a turbine 200. During operation of the turbine 200, the compressor 205 may become fouled by potentially corrosive elements within the airstream. Also an operator of the turbines 200 may use a wash system 215 to clean and reduce the level of corrosion on the compressor 205.

The following description provides an overview of an exemplary configuration of an inlet system 100; however, it should be appreciated that the present disclosure may be used with other configurations of the inlet system 100, which are not illustrated in the figures. The inlet system 100 channels the airstream drawn in by the compressor 205. The airstream usually comes from the environment in which the turbine 200 operates. Initially, the airstream flows around a weather hood 105, which may prevent weather elements, such as rain, snow, etc, from entering the compressor 205. The airstream may then flow through an inlet filter house 110; which generally removes foreign objects and debris from the airstream. Next, the airstream may flow through a cooling module 115. Next, the airstream may flow through a transition piece 120 and an inlet duct 125; these components may adjust the velocity and pressure of the airstream. Next, the airstream may flow through a silencer section 130. Next, the airstream may flow through an inlet bleed heat system 135, which generally increases the airstream temperature prior to entering the compressor 205. A screen 140, or the like, may be located downstream of the inlet duct 125 and generally serves to prevent debris from entering the compressor 205. The inlet plenum 145 may connect the inlet system 100 with the compressor 205.

In some embodiments, the wash system 215 can include a plurality of nozzles 225 located in and/or adjacent the inlet plenum 145. In some embodiments, the wash system 215 can operates while the turbine 200 is in normal operation. This may be considered an on-line wash system 215.

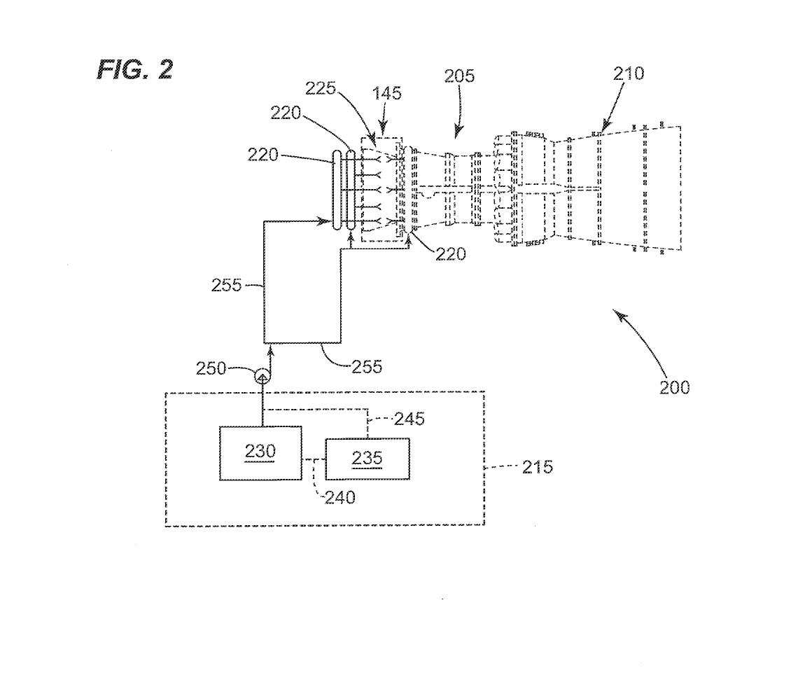

FIG. 2 is a schematic illustrating an embodiment of a wash system 215, in accordance with an embodiment for potential utilization of the present disclosure. As discussed the wash system 215 may be integrated with the turbine 200. In an embodiment of the present disclosure, the turbine 200 generally comprises: a compressor 205 and a turbine section 210. Other components of the turbine 200 are shown for illustrative purposes only. The components of the wash system 215 may be comprised of a stainless steel, or any other material capable of withstanding the operating environment to which the wash system 215 may be subjected.

Generally, on-line washing may be considered the process of injecting a cleaning fluid such as, but not limiting of, de-min water into the inlet of the compressor 205 while the turbine 200 operates near a synchronous speed. On-line washing provides the user with the advantage of cleaning the compressor 205 without shutting down the turbine 200. The aforementioned wash system 215 components along with various other piping, fittings, valves (none of which are illustrated), may be mounted on or near the turbine machine 200. It should be appreciated the washes disclosed herein may also be used via off-line washing.

The embodiments of the present invention may use at least one cleansing wash composition and/or film-forming wash composition (collectively referred to as wash compositions) to clean/neutralize the corrosives on the compressor 205 and/or provide a protective film.

In some embodiments, the wash system 215 may comprise at least one manifold 220 each of which having nozzles 225 attached and a first tank 230 for housing a wash composition. In some optional embodiments, the wash system may further comprise an optional second tank 235 for storing additional wash compositions. For example, a direct line 240 may allow the contents of the second tank 235 to enter the first tank 230 and at least one pump 250 may allow for moving the contents of the first tank 230 and the second tank 235 through the nozzles 225. Alternatively, a bypass line 245 may prevent the contents of the second tank 235 from directly entering the first tank 230 so that they can be applied separately or mix in the header 255.

The environment that the turbine 200 operates may allow for external elements, ingested by the inlet system 100, to contact the blades of the compressor 205. While the inlet filter house 110 may mitigate the effect of these compounds on the compressor 205, additional and/or alternative wash compositions may further clean and protect the compressor 205.

To assist in the cleaning and/or protection of the compressor 205, one or more washes may be applied (either on-line or off-line) such as a cleansing wash to help remove constituents deposited on one or more compressor blades and/or a film-forming wash to help protect one or more compressor blades from future constituent deposits.

For example, in some embodiments, the wash may comprise a cleansing wash that helps clean fouling deposits and the like off of the surface of the blades of the compressor 205. The cleansing wash can generally comprise one or more surfactants, one or more corrosion inhibiting dispersants, and one or more balance materials selected from a group consisting of water and solvents. As used herein, “corrosion inhibiting dispersants” refer to dispersants that help remove scales, foulants and/or other deposits that can potentially corrode compressor blades.

The one or more surfactants and the one or more corrosion inhibiting dispersants (i.e., the actives) can combine to comprise from about 1 weight percent to about 20 weight percent, as actives, of the cleansing wash. In some embodiments, the one or more surfactants and the one or more corrosion inhibiting dispersants can combine to comprise from about 5 weight percent to about 10 weight percent of the cleansing wash.

In some particular embodiments, the cleansing wash may be water-based such that the one or more balance materials consist of water. In some such water-based embodiments, the one or more surfactants may be selected from the group consisting of sodium lauryl sulphate, sodium dodecyl benzene sulphonate, and ethylene oxide and propylene oxide block copolymers. For example, the one or more surfactants can comprise up to about 30 weight percent ethylene oxide and propylene oxide block copolymers with the balance comprising sodium lauryl sulphate and sodium dodecyl benzene sulphonate.

Furthermore, in some such water-based embodiments, the one or more corrosion inhibiting dispersants may be selected from the group consisting of acrylic acid-co-allyloxy propyl hydroxy sulphates, hydroxy propyl sulphonic acid, copolymers of acrylic acid and 2-acrylamido-2-methyl-1-propane sulfonic acid, poly maleic acid, polyepoxysuccinic acid, and terpolymer of acrylic acid. In some water-based embodiments, the one or more corrosion inhibiting dispersants combine to comprise from about 10 weight percent to about 50 weight percent of the total actives.

In some particular embodiments, the cleansing wash may be solvent-based such that the one or more balance materials consist of one or more solvents. The one or more solvents may comprise, for example, heavy aromatic naphtha, toluene and/or xylene.

In some such solvent-based embodiments, the one or more surfactants may be selected from the group consisting of C9-C12 carbon chain of phenol sulphides, polyisobutylene and polyisobutylene dithio phosphonate. C9-C12 carbon chain of phenol sulphides can include, for example, calcium salt of nonyl phenol sulphide or calcium salt of dodecyl phenol sulphide. In some exemplary solvent-based embodiments, the one or more surfactants can consist of polyisobutylene dithio phosphonate and calcium salt of nonyl phenol sulphide at a ratio of from about 20:80 to about 40:60. In other exemplary solvent-based embodiments, the one or more surfactants can consist of polyisobutylene and calcium salt of dodecyl phenol sulphide at a ration for from about 20:80 to about 40:60.

Furthermore, in some such solvent-based embodiments, the one or more corrosion inhibiting dispersants may be selected from the group tributyl phosphate, 2-ethyl hexyl phosphate, C12-C16 carbon chain alkenyl di and tri carboxylic acids, and benzene tri/tetra carboxylic acids.

In other embodiments, the wash may comprise a film-forming wash that helps protect the blades of the compressor 205 from future deposits by forming a film on the surface of the blades. The film-forming wash can generally comprise one or more bases selected from a group consisting of water and solvents, one or more fluoro silanes, and, one or more additional silanes selected from the group consisting of mercapto silane, amino silane, tetraethyl orthosilicate, and succinic anhydride silane, wherein the ratio of the one or more fluoro silanes to the one or more additional silanes is from about 90:10 to about 50:50, and wherein the one or more fluoro silanes and the one or more additional silanes combine to comprise from about 0.5 weight percent to about 10 weight percent of the film-forming wash composition.

The film-forming wash can be water-based or solvent-based. For example, in water-based formulations, the pH of the water may be adjusted from about 4.5 to about 5.5 using acetic acid while then adding silane to achieve a concentration of from about 0.5% to about 2%. For solvent-based formulations, the pH of, for example, 95% ethanol and 5% water may be adjusted to 4.5 to about 5.5 while adding silane to achieve a concentration of from about 0.5% to about 2%.

The film-forming wash can leave a thin film on the surface of the compressor (such as on the surface of one or more blades of the compressor) to help limit future corrosion from foulants and other deposits. For example, the one or more fluoro silanes of the film-forming wash can function as an anti-foulant and/or inhibit corrosion while one or more additional silanes can function as a corrosion inhibitor while also impart binding between the film and the compressor.

In some embodiments, the resulting film can withstand temperatures of at least about 350° C. As used herein “withstand” refers to not showing significant signs of degradation after prolonged exposure to the elevated temperature. Moreover, the film can also be hydrophobic and oleophobic to help prevent the resident buildup of fluids (e.g., water and oil) and/or other foulants. “Hydrophobic” refers to the physical property of a material that is water repellent. “Oleophobic” refers to the physical property of a material that is oil repellent. Specifically, surfaces with low surface energy for a foulant (e.g. water and/or oil) should have a high contact angle and should provide reduced adhesion with the foulant relative to a surface which is wet by the foulant or with which the foulant has low contact angle. As used herein, the term “contact angle” is the angle formed by a static liquid droplet on the surface of a solid material. The higher the contact angle, the less the interaction of the liquid with the surface. Thus, it is more difficult for the foulant to wet or adhere to the surface if the contact angle of the oil or other foulant with the surface is high. For example, the coating can have a contact angle of at least about 135 degrees.

While specific embodiments of cleansing washes and film-forming washes have been presented herein, it should be appreciated that these are non-limiting examples and other compositions incorporating additional and/or alternative materials may also be realized.

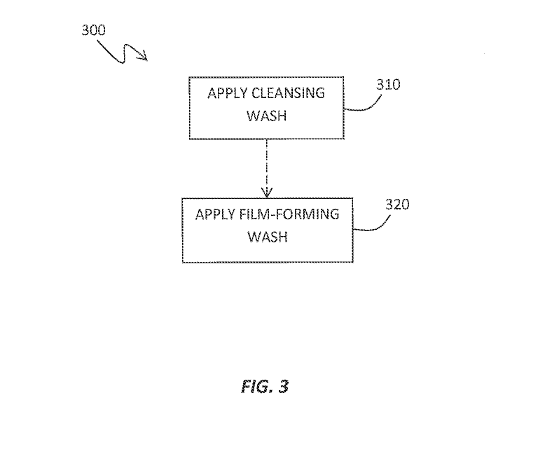

Referring now to FIG. 3, a method 300 is illustrated for washing a compressor 205 section of a turbine 200. The method 300 comprises applying a cleansing wash in step 310 to a surface of one or more blades of the compressor 200. As discussed above, the cleansing wash can generally comprise one or more surfactants; one or more corrosion inhibiting dispersants; and one or more balance materials selected from a group consisting of water and solvents. The cleansing wash can be applied in any sufficient manner such as through the spraying via one or more nozzles 225 of the wash system 215. Furthermore the cleansing wash may be applied for any sufficient time and either on-line, off-line or both so as to help remove any foulants, scaling, or other constituents deposited on the compressor.

Still referring to FIG. 3, the method 300 may optionally further comprise applying a film-forming wash in step 320. As discussed above, the film-forming wash can generally comprise one or more bases selected from a group consisting of water and solvents, one or more fluoro silanes, and, one or more additional silanes selected from the group consisting of mercapto silane, amino silane, tetraethyl orthosilicate, and succinic anhydride silane, wherein the ratio of the one or more fluoro silanes to the one or more additional silanes is from about 90:10 to about 50:50, and wherein the one or more fluoro silanes and the one or more additional silanes combine to comprise from about 0.5 weight percent to about 10 weight percent of the film-forming wash composition. The film-forming wash can be applied in any sufficient manner after the cleansing wash such as through the spraying via one or more nozzles 225 of the wash system 215. Furthermore the film-forming wash may be applied for any sufficient time and either on-line, off-line or both so as to help remove any foulants, scaling, or other constituents deposited on the compressor.

It should now be appreciated that cleansing washes and/or film-forming washes can be used to clean turbine compressors. Cleansing washes can be used to remove constituents deposited on one or more compressor blades and film-forming washes can be used to help protect one or more compressor blades from future constituent deposits. The use of one or both types of washes may thereby promote longer operation of compressor components with reduced wear.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A cleansing wash for a compressor section of a turbine, the cleansing wash comprising:
one or more surfactants;
one or more corrosion inhibiting dispersants; and
one or more balance materials selected from a group consisting of water and solvents, wherein the one or more surfactants and the one or more corrosion inhibiting dispersants combine to comprise from about 1 weight percent to about 20 weight percent, as actives, of the cleansing wash.

2. The cleansing wash of claim 1, wherein the one or more surfactants and the one or more corrosion inhibiting dispersants combine to comprise from about 5 weight percent to about 10 weight percent, as actives, of the cleansing wash.

3. The cleansing wash of claim 1, wherein the one or more balance materials consists of water.

4. The cleansing wash of claim 3, wherein the one or more surfactants are selected from the group consisting of sodium lauryl sulphate, sodium dodecyl benzene sulphonate, and ethylene oxide and propylene oxide block copolymers.

5. The cleansing wash of claim 4, wherein the one or more surfactants comprise up to about 30 weight percent ethylene oxide and propylene oxide block copolymers and the balance comprising sodium lauryl sulphate and sodium dodecyl benzene sulphonate.

6. The cleansing wash of claim 3, wherein the one or more corrosion inhibiting dispersants are selected from the group consisting of acrylic acid-co-allyloxy propyl hydroxy sulphates, hydroxy propyl sulphonic acid, copolymers of acrylic acid and 2-acrylamido-2-methyl-1-propane sulfonic acid, poly maleic acid, polyepoxysuccinic acid, and terpolymer of acrylic acid.

7. The cleansing wash of claim 3, wherein the one or more corrosion inhibiting dispersants combine to comprise from about 10 weight percent to about 50 weight percent of the total actives.

8. The cleansing wash of claim 1, wherein the one or more balance materials consists of one or more solvents.

9. The cleansing wash of claim 8, wherein the one or more solvents are selected from the group consisting of heavy aromatic naphtha, toluene and xylene.

10. The cleansing wash of claim 8, wherein the one or more surfactants are selected from the group consisting of C9-C12 carbon chain of phenol sulphides, polyisobutylene and polyisobutylene dithio phosphonate.

11. The cleansing wash of claim 10, wherein the one or more surfactants consists of polyisobutylene dithio phosphonate and calcium salt of nonyl phenol sulphide at a ratio of from about 20:80 to about 40:60.

12. The cleansing wash of claim 10, wherein the one or more surfactants consists of polyisobutylene and calcium salt of dodecyl phenol sulphide at a ratio for from about 20:80 to about 40:60.

13. The cleansing wash of claim 8, wherein the one or more corrosion inhibiting dispersants are selected from the group consisting of tributyl phosphate, 2-ethyl hexyl phosphate, C12-C16 carbon chain alkenyl di and tri carboxylic acids, and benzene tri/tetra carboxylic acids.

14. A method of washing a compressor section of a turbine, the method comprising:
applying a cleansing wash to a surface of one or more blades of the compressor, the cleansing wash comprising:
one or more surfactants;
one or more corrosion inhibiting dispersants; and
one or more balance materials selected from a group consisting of water and solvents, wherein the one or more surfactants and the one or more corrosion inhibiting dispersants combine to comprise from about 1 weight percent to about 20 weight percent, as actives, of the cleansing wash.

15. The method of claim 14, further comprising applying a film-forming wash to the surface of one or more blades of the compressor, the film-forming wash comprising:
one or more bases selected from a group consisting water and solvents;
one or more fluoro silanes; and,
one or more additional silanes selected from mercapto silane, amino silane, tetraethyl orthosilicate, and succinic anhydride silane, wherein the ratio of the one or more fluoro silanes to the one or more additional silanes is from about 90:10 to about 50:50, and wherein the one or more fluoro silanes and the one or more additional silanes combine to comprise from about 0.5 weight percent to about 10 weight percent of the film-forming wash.

16. A film-forming wash for a compressor section of a turbine, the film-forming wash comprising:
one or more bases selected from a group consisting of water and solvents;
one or more fluoro silanes; and,
one or more additional silanes selected from the group consisting of mercapto silane, amino silane, tetraethyl orthosilicate, and succinic anhydride silane, wherein the ratio of the one or more fluoro silanes to the one or more additional silanes is from about 90:10 to about 50:50, and wherein the one or more fluoro silanes and the one or more additional silanes combine to comprise from about 0.5 weight percent to about 10 weight percent of the film-forming wash.

17. The film-forming wash of claim 16, wherein the film-forming wash leaves a film on the compressor after washing.

18. The film-forming wash of claim 17, wherein the film withstands temperatures of at least about 350° C.

19. The film-forming wash of claim 18, wherein the film is hydrophobic and oleophobic such that it has a contact angle of at least about 135 degrees.

20. The film-forming wash of claim 16 wherein the pH of the one or more bases is adjusted to from about 4.5 to about 5.5 before adding the one or more fluoro silanes and the one or more additional silanes.
